(19) United States
(12) Patent Application Publication
(10) Pub. No.: US 2013/0309642 A1
(43) Pub. Date: Nov. 21, 2013

(54) Method for Teaching Social Behavior

(71) Applicant: LYNN H. SINGLETARY, BATON ROUGE, LA (US)

(72) Inventor: LYNN H. SINGLETARY, BATON ROUGE, LA (US)

(21) Appl. No.: 13/938,678

(22) Filed: Jul. 10, 2013

Related U.S. Application Data
(63) Continuation-in-part of application No. 13/817,507, filed on Feb. 18, 2013.
(60) Provisional application No. 61/410,271, filed on Nov. 4, 2010.

(51) Int. Cl. G09B 19/00

(52) U.S. Cl. CPC G09B 19/00
USPC 434/236

(57) ABSTRACT

A method for teaching social behavior to students comprising the steps of identifying rules of conduct, establishing positive consequences for obeying the rules of conduct and establishing negative consequences for disobeying the rules of conduct, teaching the students the rules of conduct and the consequences for obeying and disobeying the rules of conduct, tracking and recording on a periodic basis the conduct of students in disobeying the rules of conduct, establishing a grading scale and assigning to the students a grade based on their conduct and the grading scale, monitoring over time the changes to the grade, conducting behavior class for the students, and re-evaluating the grading scale based on the grade made by the students over time. In addition, a computer-implemented method for tracking student behavior and for tracking student and teacher performance is provided.

### CROSS-REFERENCE TO RELATED APPLICATION

This application is a continuation-in-part of U.S. application Ser. No. 13/817,507, filed Feb. 8, 2013, now pending, which was the National Stage of International Application No. PCT/US11/59306, filed Nov. 4, 2011, which claims the benefit of U.S. Provisional Application No. 61/410,271, filed Nov. 4, 2010. Each patent application identified above is incorporated here by reference in its entirety to provide continuity of disclosure.

### STATEMENT REGARDING FEDERALLY SPONSORED RESEARCH OR DEVELOPMENT

Where a Government contractor retains U.S. domestic patent rights, the contractor is under an obligation by virtue of 35 U.S.C. 202(c)(6) to include the following statement at the beginning of the application and any patents issued thereon:

This invention was made with government support under (identify the contract) awarded by (identify the Federal agency). The government has certain rights in the invention.

### THE NAMES OF THE PARTIES TO A JOINT RESEARCH AGREEMENT

The specification may disclose or be amended to disclose the names of the parties to a joint research agreement (35 U.S.C. 103(c)(2)(C)).

### BACKGROUND OF THE INVENTION

1. Field of the Invention

This invention relates in general to a method for teaching social behavior, and more particularly to a method for teaching social behavior to students in a classroom environment.

2. Description of Related Art

Schools today are undergoing extraordinary changes in terms of teacher quality and school accountability, reflecting the importance of academic achievement for successful participation in contemporary society. Federal legislation, such as the No Child Left Behind Act (NCLB) and Individuals with Disabilities Education Improvement Act (IDEIA), reflect the importance of academic achievement in school. NCLB places the responsibility on teachers and administrators to ensure that students make adequate academic progress. It is recognized in the teaching profession that good behavior and discipline of students are essential to academic learning. It is also recognized that inappropriate behavior and lack of discipline impair the quality of teaching and learning. Instrumental in obtaining good behavior and discipline of students is the teacher who is accountable for teaching, monitoring, assessing, and improving student academic behavior, as reflected in test scores. However, effective classroom management requires a depth of knowledge and skill sets to implement. In many cases teachers do not receive adequate training and support to implement data-based learning plans.

Early social behavior programs were designed to react to bad behavior and lack of discipline and to utilize aversive types of management strategies. The current social behavior programs are designed to be positive, proactive and incorporate preventive strategies into school wide discipline plans. Such programs included a tiered service delivery model that utilizes early screening and universal evidence-based instruction that depends on baseline assessment of present skills with frequent monitoring that allows for adjustments and which develops data to identify students that would benefit from increasingly intensive interventions.

Despite the research and program testing there still exists a need for universal or Tier I strategies for teaching students social behavior that is efficient and effective, and is one that teachers can be easily trained to administer in the classroom environment.

### BRIEF SUMMARY OF THE INVENTION

Therefore, one object of this invention is to provide a universal method for teaching students social behavior in a classroom environment.

Another object of this invention is to provide a universal method for teaching students social behavior in a classroom environment that teachers can be easily trained to administer.

Still another object of this invention is to provide a universal method for teaching students social behavior in a classroom environment that allows teachers to record data, such as with a handheld computer, with as little impact on classroom instruction as possible and to minimize time spent with the administrative aspects of the method.

Other objects and advantages of this invention shall become apparent from the ensuing descriptions of the invention.

Accordingly, this invention in one embodiment comprises a universal method for teaching students social behavior in a general classroom environment that provides a framework for teachers to teach and monitor class wide social behavior that utilizes behavior classes and rules. There are eight basic steps of the method: (1) establishing the rules of conduct, (2) establishing consequences for obeying and disobeying the rules of conduct, (3) establishing a daily tracking system of a student disobeying the rules of conduct, (4) establishing a grading scale of a student's social behavior based on the information gathered from the daily tracking system, (5) utilization of an initial behavior class to explain the social behavior training, (6) monitoring over time a student's progress in learning the established rules of conduct, (7) changing the grading scale once a predetermined level of progress has been achieved or once a predetermined time period of training has been concluded, and (8) ongoing class training of the pro-social behavior.

In another embodiment, the invention comprises a computer-implemented method for tracking a student's behavior that includes tracking and recording the conduct of the student in disobeying rules of conduct. In another embodiment, the invention comprises a computer implemented method for tracking student or teacher performance that includes tracking and recording instances of a student disobeying rules of conduct; and generating reports based on the tracked and recorded instances of a student disobeying rules of conduct.

### BRIEF DESCRIPTION OF THE SEVERAL VIEWS OF THE DRAWING(S)

The accompanying drawings illustrate a preferred embodiment of this invention. However, it is to be understood that this embodiment is not intended to be exhaustive, nor limiting of the invention. It is but one example of the method of teaching social behavior.

FIG. 1 is a graph of the total number of rules of conduct violations by a class over a two week period.

FIG. 2 is a graph of the total number of students in a class that have achieved an “A” grade over a two week period.

FIG. 3 illustrates an embodiment of a report in accordance with this invention showing class performance over a particular time with a summary the performance of each student in the class.

FIG. 4 illustrates an embodiment of a report in accordance with this invention showing a student's performance compared to the rest of the students in a particular class.

FIG. 5 illustrates an example of a students' progress during the first 9 weeks of school.

FIG. 6 illustrates an example of a graph that monitors the number of daily violations for a student.

### DETAILED DESCRIPTION OF THE INVENTION

It has been recognized that there are three major components to effective teaching: instruction of academic learning, establishing and maintaining routines and procedures, and general classroom management or instruction of social behavior. This invention is directed to a method for training students in pro-social behavior that will facilitate better classroom management and, in turn, allowing for providing better academic instructions and implementation of routines and procedures during the teaching process.

One of the unique aspects of this invention is that it is a universal program intended for use in the general classroom. It is comprised of eight steps that have been systematically integrated for teacher implementation across the school year. The first steps in this method are establishing specific rules of conduct, establishing fixed time periods students will receive reinforcement for rule following, establishing specific consequences for obeying or disobeying the rules of conduct, establishing a daily tracking system of non-compliance with the rules of conduct, and establishing a grading scale to measure the level of compliance with the rules of conduct. With these matters established the next step is to conduct an initial class to explain the training program to the students, including how they will be graded. Upon completion of the initial class a teacher will begin to monitor over time the behavior of the students and record the instances that one or more of the rules of conduct have not been obeyed. After a student or classroom has achieved a pre-determined level of proficiency in obeying the rules of conduct, the grading scale is modified to require a higher level of proficiency to achieve the same grade. Alternatively, the grading scale can be modified after a predetermined period of time of monitoring has been achieved. During the monitoring period continual class instruction is conducted and students receive the predetermined consequences for obeying or disobeying the rules of conduct.

1. Establishing the Rules of Conduct.

Any rule of conduct that is used in this method must have two characteristics: it must be easily observable by the teacher in the classroom environment and it must be readily measurable. The rule should also be one that is easily understood by the students. In addition, the rules of conduct should be selected to achieve one or more of the following objectives: order in the classroom, compliance with teacher instructions, safety of all students, respect of the other students and the teacher, and acceptable social behavior. It has been found that the following five rules of conduct have the two desired characteristics, are easily understood by students and will together achieve all of the desired objectives: (i) student must follow the teacher's direction; (ii) student must keep his/her hands, feet and objects to himself/herself; (iii) student must raise his/her hand to get the teacher's attention; (iv) student must remain in an assigned area with appropriate behavior; and (v) student must keep unkind and/or disrespectful remarks to himself/herself.

Depending on the classroom situation, it may be desirable to also include other rules of conduct or behaviors that will be monitored. For example, if the teacher observes a particular behavior problem (e.g. student using a loud voice of marking noises), then this could be added to the rules of conduct and/or monitored for intervention purposes. However, the number of rules of conduct should be minimized so not to make monitoring or recording of the instances of disobeying a rule of conduct substantially distract from the teacher providing academic teaching or maintaining set classroom routines and procedures. It has been found that utilization of these rules in the method will result in teaching clear, unambiguous, and explicit behaviors that increase time available for teaching a subject matter as well as maintain positive social interactions among the students in the classroom.

Table I below provides a summary of the purpose or purposes that each of the five preferred rules is designed to achieve.

TABLE I
Objectives to be Achieved by Each of the Rules of Conduct

| | | Compliance | | Respect of | |
|---|---|---|---|---|---|
| | Order in | with | Safety of | the Other | |
| RULES OF | the | Teacher | All | Students and | Acceptable |
| CONDUCT | Classroom | Instructions | Students | Teacher | Social Behavior |
| Student Must | YES | YES | | | |
| Follow the | | | | | |
| Teacher's | | | | | |
| Direction | | | | | |
| Student Must | | | YES | YES | YES |
| Keep His/Her | | | | | |
| Hands, Feet and | | | | | |
| Objects to | | | | | |
| Himself/Herself | | | | | |
| Student Must | YES | | | YES | |
| Raise His/Her | | | | | |
| Hand to Get | | | | | |
| Teacher's | | | | | |
| Attention | | | | | |
| Student Must | YES | | YES | | |
| Remain in an | | | | | |
| Assigned Area | | | | | |
| with | | | | | |
| Appropriate | | | | | |
| Behavior | | | | | |
| Student Must | YES | | | YES | YES |
| Keep Unkind | | | | | |
| and/or | | | | | |
| Disrespectful | | | | | |
| Comments to | | | | | |
| Himself/Herself | | | | | |

Table II below provides for each rule of conduct the specific acceptable behavior that a student is to be trained to perform.

| | | | Student | | |
|---|---|---|---|---|---|
| | | Student Must | Must | | |
| | | Keep | Raise | Student Must | |
| | Student | His/Her | His/Her | Remain in an | Student Must |
| | Must | Hands, Feet | Hand to | Assigned Area | Keep Unkind |
| | Follow the | and Objects | Get | with | Remarks to |
| RULES OF | Teacher's | to Himself/ | Teacher's | Appropriate | Himself/ |
| CONDUCT | Direction | Herself | Attention | Behavior | Herself |
| ACCEPTABLE | As the | Keep hands on | Raise your | Sit upright - with | Speak |
| BEHAVIOR | teacher | desk, in your | hand and | straight back in | positively |
| EVENTS OF | talks or give | personal space, | stay silent | chair and feet flat | about another |
| OBEYING | directions, | and on your | while | on floor with all | person place or |
| RULES OF | stay silent | school | continuing | four chair legs on | object; |
| CONDUCT | and still and | materials unless | to work | the floor; | Smile, look at |
| | look | given | on | Stay in the area | the other |
| | directly at | permission to | another | assigned by your | person as they |
| | the teacher; | do otherwise; | page or | teacher; | talk, nod your |
| | Begin the | Keep feet on | problem | Walk with one | head as you |
| | task when | the floor under | or wait | foot in front of | listen; |
| | teacher tells | your desk and | quietly; | the other in a | If another |
| | you to | in your | Raise your | slow to moderate | person hurts |
| | begin | assigned area; | arm/hand | pace inside | your feelings, |
| | within 3-5 | Keep your desk | in the air - | classroom/school | walk away and |
| | seconds; | and area neat | full arm | | think positive |
| | Raise your | and organized | extension - | | thoughts; |
| | hand and | with only your | and wait | | |
| | ask | school | silently for | | |
| | questions if | materials | the | | |
| | you do not | | teacher to | | |
| | understand | | call on | | |
| | the | | you; | | |
| | directions | | With | | |
| | or you have | | teacher | | |
| | a question | | permission, | | |
| | | | walk to | | |
| | | | teacher | | |
| | | | and ask | | |
| | | | your | | |
| | | | question | | |

Table III below provides for each rule of conduct examples of disobeying behavior that a teacher will be monitoring and recording.

| | | | Student | | |
|---|---|---|---|---|---|
| | | | Must Raise | | |
| | | Student Must | His/Her | Student Must | |
| | Student Must | Keep His/Her | Hand to | Remain in an | Student Must |
| | Follow the | Hands, Feet and | Get | Assigned Area | Keep Unkind |
| RULES OF | Teacher's | Objects to | Teacher's | with Appropriate | Remarks to |
| CONDUCT | Direction | Himself/Herself | Attention | Behavior | Himself/Herself |
| MEASURABLE | does not begin | touching others; | talking out | bottom out of seat; | talking back to |
| AND | task within 3-5 | grabbing; | on and off | standing by desk; | teacher; |
| OBSERVABLE | seconds; | kicking; | topic; | walking or | verbalize |
| EVENTS OF | any diversion | throwing; | talking to | wandering about; | derogatory, |
| DISOBEYING | from on task; | breaking objects; | peers; | leaving center area; | offensive words; |
| RULES OF | looks away | fighting; | yelling out; | leaving classroom; | cursing; |
| CONDUCT | from task; | slapping; | whistling; | running or | physical gestures; |
| | fidgets with | pushing; | making | skipping; | mean, insulting |
| | materials or | putting hands, | noises; | head on arm or | comments; |
| | clothes | feet or objects on | derogatory | desk; | negative and |
| | | others desk, chair, | comments to | kneeling in chair | sarcastic body |
| | | materials; | others; | slumped down in | language (rolling |
| | | aggression; | mouthing or | chair | eyes, shifting hips, |
| | | taking items | signing to | | tilting head) |
| | | | another | | |
| | | | student; | | |
| | | | talking back | | |
| | | | to teacher; | | |
| | | | cursing | | |

2. Establishing Consequences.

Positive reinforcement is critical to the learning process. When students engage in appropriate classroom behavior, the provision of positive reinforcement will either increase or maintain appropriate behavior. Reinforcement should be delivered frequently and focus on student accomplishments. The teacher should use different types of reinforcement (e.g., praise, edible, tangible, social, etc.) provided at fixed or scheduled time periods and randomly as appropriate behavior is observed.

To increase appropriate behavior in the classroom, it is preferred to focus on the positive. When appropriate behavior is observed, the provision of a high five, a smile, a thumbs up or other types of incentives such as fun activities (e.g., class game of soccer, free or play time), tangibles (i.e., trinkets such as school supplies, toys, coupons), and edible items (i.e., candy, popcorn, juice, etc.) can be used to reinforce or maintain or strengthen the positive behavior. Providing students with a treasure chest or bank of choices for appropriate behavior may increase their motivation and encourage appropriate behavior.

The method of this invention teaches students to rule follow; however, when students violate a rule in the classroom, they earn a demerit which may be recorded as a checkmark or other symbol. The absence of a demerit is equal to rule following. When students rule follow, they earn good grades and extra incentives delivered daily and weekly.

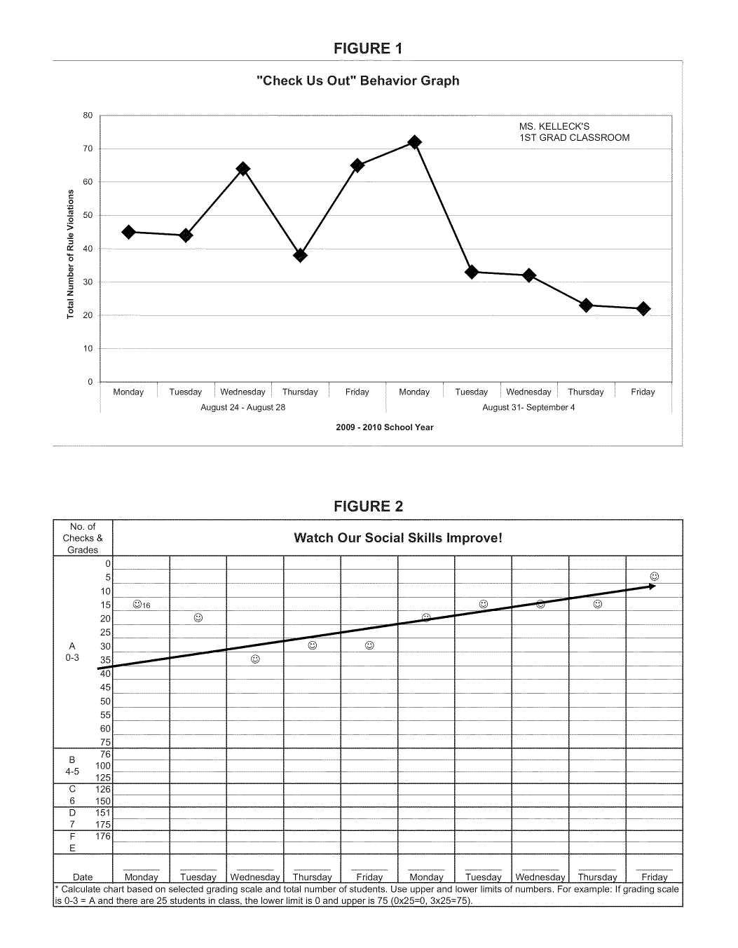

Students are responsible for their own behavior, however, a class wide plan that promotes overall class behavior may be reinforcing for the collective class. Posting an enlarged line graph such as illustrated in FIG. 1 in a visible location that is titled “Check Us Out,” or similarly titled, will keep the students focused on increasing rule following behavior. It is preferred that this poster be updated every day by adding the class total number of violations to the chart at the end of the day. The goal is to decrease rule violations over time. It is also important to provide feedback about group behavior. For example, if as a group, there is one less check than the day before, all students may earn a “thumbs up” sticker, or coupon to be used at the school store or some other type reward. Most students like seeing the downward slope of the line which means they are meeting their goal and engaging in more appropriate behavior. Alternatively, a chart such as illustrated in FIG. 2 that focuses on an upward data trend which means students are making fewer mistakes and working toward the “A” grading range could be posted.

In addition to smiling at students and providing verbal and/or labeled praise, determining a schedule of reinforcement will promote continuous appropriate behavior in most all students. The first step is generating precise rules that describe how and when reinforcement will be presented. The rules should include the number of rule violations allowed (e.g., 0-1) to earn reinforcement and the time the reinforcement will be delivered. Deciding on a routine time or fixed interval schedule (i.e., every hour, 2 hours, twice daily, end of day, end of week) to deliver the positive reinforcement ensures that students will receive what they have earned. In choosing a schedule of reinforcement for the whole class, it is necessary to consider rates of inappropriate behavior. Classes that engage in inappropriate behaviors at a high frequency (e.g., 8-15 reprimands per hour) may benefit from a richer schedule (i.e., every hour, every 2 hours, or by activity). In order to raise expectations, determine short and long term goals. Short term goals consist of daily and/or weekly and long term may be monthly and/or every grading cycle.

Students engaging in inappropriate classroom behavior (i.e., rule violating) should receive extra training and also earn a negative consequence or penalty such as a demerit. When students engage in a rule violation, they can earn a demerit and add a check or mark to their conduct card. This mark serves as a reminder to listen to the teachers. The more demerits received, the lower the conduct grade. For example, the grading scale in use can allow students to engage in one or two rule violatins and earn a conduct grade of an “A.” Students should know the classroom expectations and what they will earn when they engage appropriately and inappropriately.

The way classroom expectations are designed (i.e., explicitly taught, observable, and measurable) allows for an uncomplicated process for delivering the negative consequences as the inappropriate behavior is occurring or after its occurrence. The inappropriate behavior must be addressed and tracked. Each instance should be observed and counted (e.g., tally marks, checkmarks, movement of a behavior marker on poster, etc.). How this type of behavior is addressed ranges from least intrusive (e.g., redirection and/or check mark) to most (e.g., lower conduct grade, missing fun Friday, parental contact or office referral).

More importantly and as discussed in further detail below, students need ongoing training and support. Negative or reductive consequences should be used with care. The majority of students having difficulty engaging in the expected behaviors benefit more from training, support, and practice than time out or office referrals. This is a universal plan; therefore, the data from the plan should be analyzed and interventions should be provided to students as needed.

3. Tracking System.

The step in the method includes the documentation of instances of following and violating classroom rules. Student attendance can also be tracked. Tracking is accomplished with either a teacher marking a paper tracking chart or entering a violation on a computer, preferably a handheld computer using a program or application (e.g. web based application). A computer based tracking system can permit teachers to record data with little impact on instruction and to minimize time spent with administrative items.

In one embodiment, the computer comprises a central processing unit (CPU) and a memory unit having a control logic stored therein to document instances of following and violating classroom rules. Examples of the memory unit include, but are not limited to, magnetic storage devices (e.g., hard disk, floppy disk, magnetic strips, etc.), optical disks (e.g., compact disk (CD), digital versatile disk (DVD), etc.), smart cards, and flash memory devices (e.g. card, stick, key drive, etc). Of course, those skilled in the art will recognize many modifications may be made to this configuration without departing from the scope or spirit of the claimed subject matter.

When a student rule violates, for example, the teacher taps the handheld screen or places a check on the paper tracking chart which is a permanent record of child behavior. In this manner, the teacher can document instances of following and violating classroom rules at or near the actual time they occur. The absence of checks during a time period means appropriate rule following was observed. The record being created includes identifying information such as student names, the rules, and class sessions. For example, a teacher may determine it is necessary to reinforce rule following each class. Therefore, the record would include each class. At the end of each class, the teacher provides students with the earned reinforcement and then starts over with the next class. This continues until the end of the day. Student's daily grade is based on the number of rule violations they earned across the day.

Teaching students to self-monitor and ultimately learn behavioral self-control is the end goal. As the teacher “reminds” the student of the rule violation and provides the earned consequences, most students over time will learn not to rule violate. Students should have a form of the tracking system within their control (i.e., student monitoring card on their desk, behavior log, behavior notebook, computer application or program, etc.). For example, during the beginning stages of learning, when a student rule violates, the teacher can walk to the student's desk, tell them the right thing to do next time and place the checkmark on the card. With guidance from the teacher, the student can learn to keep track of their own rule following behavior. During different times of the day, the teacher should make sure that students are accurately placing checks on their cards. Both the teacher record and student conduct cards are data collection tools for gathering rule following behavior and isolating problem behaviors that occur at different times of the school day. If desired, other special marks (such as “ [symbol] ”) can be recorded reflecting positive social behavior by a student.

As discussed above, the tracking system provided to the student can also be a computer application or program on a computer (e.g. desktop, notebook, laptop, handheld computer, and so forth). The application can be a web application that is accessed over a network such as the Internet or Intranet. The application may be accessed using a web browser. The computer application can permit the student to self-report their behavior (e.g. rule violations by class). Information reported by the student can be stored in a database and compared to information reported by the teacher in a similar manner. By comparing the information, the accuracy of the information submitted by the student can be checked. If the student accurately reports the information, then they can receive a reward or other positive reinforcement (e.g. gem). Student can also see their behavior grade and/or a do good message.

The following provides an example of a student conduct card.

Student Name:
Date:

| | | Rule 2: | | | | |
|---|---|---|---|---|---|---|
| | | Keep | Rule 3: | | Rule 5: | |
| | Rule 1: | Hands, | Raise Your | Rule 4: | Keep | |
| | Follow | Feet and | Hand When | Stay in Your | Unkind | |
| | Teacher's | Objects | you Need | Assigned | Comments | |
| TIME PERIODS | Direction | to Self | Assistance | Area | to Self | |
| 8:30-10:00 | | | | | | [symbol] |
| Reading Block | | | | | | |
| 10:00-11:30 | | | | ✓ | | 1 |
| Science/SS | | | | | | |
| 11:30-1:00 | | | | | | [symbol] |
| Lunch, Recess, | | | | | | |
| Spelling, Computers | | | | | | |
| 1:00-2:30 | | | | | | [symbol] |
| Math | | | | | | |
| 2:30-3:30 | | ✓ ✓ | | | | 2 |
| SS, Art, End of Day | | | | | | |
| Routine | | | | | | |
| Total Number of | 0 | 2 | 0 | 1 | 0 | 3 |
| Rule Violations | | | | | | |
| Parent Signature | | | | | | A |

4. Grading Scale.

Once the classroom expectations are clearly defined and described, it is necessary to define the outcome that students are expected to accomplish. Developing a rubric keeps grading objective and less judgmental. This can be achieved by working backward and determining criteria or performance levels that students should be able to demonstrate. This includes levels ranging from the highest performance or “A” or “Outstanding” behavior to the lowest performance or “F” or “Yikes” behavior. Each performance level or anchor should be observable and clearly understood by all students. Performance anchors should be assigned and have both qualitative and quantitative descriptions.

Most students are rule followers and learn fairly quickly to listen to the teacher. All students should receive praise and corrective feedback often. To increase or strengthen rule following and appropriate social skills, it is best to reinforce the appropriate behavior as soon as it occurs. During the initial class training it is important to use verbal praise, thumbs up, and happy eye contact as often as possible. As student behavior becomes more appropriate and fewer mistakes are made, the grading scale is changed. For example, when 85-90% of students are making an A or B in conduct for a period of time (i.e., 1 grading cycle or ½ of the grading cycle), it is appropriate to increase your behavior expectations. Instead of reinforcing 0-3 mistakes during a time period, only students with 0-2 mistakes may earn a sticker.

Right from the start, everyone should have the opportunity to receive reinforcement. Therefore, it is important that students know how to earn both reinforcement and penalties. During the teaching process, keep in mind that some students may have difficulty maintaining “A” or “Super Star” behavior in the beginning, but with practice and feedback, an increase in rule following behavior should be observed. To plan for the school year, begin by dividing the school year into manageable units. First determine a daily reinforcement schedule such as every hour or by activity such as reading block, math and science, or beginning, middle, and end of day. The initial schedule should include more frequent periods of reinforcement (i.e., a richer schedule) and as students become more proficient, the times between reinforcement lengthens. In other words, it should be “easier” in the beginning to earn reinforcement and progressively become more difficult to earn an A.

Some teachers teach the same students all day and some teach many students. There are two important items to consider when determining a schedule of reinforcement. First, determine what “A” or “Super Star” behavior looks like (e.g., 0-3 mistakes or rule violations for the day or time period). Continue to determine the criteria for each letter grade (i.e., A, B, C, D, or F) or label (e.g., Super Star, Star, Shiny Good, Keep Practicing, etc.). Second, determine when you will provide reinforcement for “A” behavior (e.g., at the end of each hour or class period, after each subject or activity, every two hours, ½ day, at the end of the day). The key is to determine a fixed time in which students can expect to receive feedback (e.g., thumbs up, sticker, candy, verbal praise, corrective feedback, etc.) about their behavior.

“Fixing” or establishing a set time is helpful for the teacher and the students. Most teachers get very involved in teaching and may “forget” to stop and provide reinforcement. Usually teachers do stop to correct or reprimand, but often forget to praise. This could upset the positive balance in the classroom and maladaptive behaviors could spiral out of control.

Students earn checks when they do not follow the rules (i.e., rule violation) and their conduct or social behavior grade is based on the number of rule violations. The number of rule violations assigned to a letter grade or label of performance is different depending on the grading scale in use. Rule following is indicated by the lack of checks and equals *0* and the number of rule violations ranges from “1” to “X” or a number greater than 1. Students can earn conduct grades by subject, time periods within the day, day, or time period such as nine weeks reporting period

Students earn a letter grade (e.g., A, B, C, etc.) or label of performance (e.g., S, US, NI, Super Star, Star, Good, etc.) for a time period (e.g. end of a class session, end of the day, and so forth) based on the total number of checks.

Students earn a weekly grade by adding the total number of checks for the week and dividing by days in school for an average number of rule violations. The average number of rule violations is assigned a letter grade or level of performance based on the selected grading scale.

One novel feature of this method is the evolving grading scale used for reporting social behavior progress. An example of such an evolving grading scale is indicated in the chart below.

| | | | Grading Rubrics | | | | | | | |
|---|---|---|---|---|---|---|---|---|---|---|
| | | | Grading | | Grading | | Grading | | Grading | |
| | | | Period 1 | | Period 2 | | Period 3 | | Period 4 | |
| | | | R1 | R2 | R3 | R4 | R5 | R6 | R7 | R8 |
| Weeks | Pre K/K | Grades 1+ | 1-4 | 5-9 | 10-13 | 14-18 | 19-22 | 23-27 | 28-31 | 32-36 |

Red

| | | | | | | | | | | |
|---|---|---|---|---|---|---|---|---|---|---|
| (about 75% of class | Super | A | 0.4 | 0-4 | 0-4 | 0-3 | 0-3 | 0-3 | 0-2 | 0-2 |
| is off task/high | Good | B | 5-7 | 5 | 5 | 4-5 | 4 | 4 | 3-4 | 3 |
| | Ok | C | 8-9 | 6-7 | 6-7 | 6 | 5 | 5 | 5 | 4 |
| | Yikes | D | 10 | 8 | 8 | 7 | 6 | 6 | 6 | 5 |
| | | F | 11+ | 9+ | 9+ | 8+ | 7+ | 7+ | 7+ | 6 |

In this example the school year of 36 weeks is divided into four grading periods in which there are eight different grading scales (R1-R8). In Grading Period 1 the same grading scale R1 is utilized for weeks 1-4; however for weeks 5-9 grading scale R2 is utilized wherein it becomes more difficult (must have fewer demerits or checks) to earn a B or C and more difficult to avoid earning a D or F. As the school year progresses the grading standard is progressively raised. However, the grading scale needs to be consistent at least across the week and should not change in the middle of a week.

The grading scales can be determined for the school year by weeks and by grading period. Preferably, a scale change would occur when 85% to 95% of students are earning weekly grades of either an A or B or an average of A or B for a minimum of 3 weeks. Another way to change scales is to assign a rubric to a time period (e.g., Weeks 1-4, Weeks 5-9, etc.) and then if by the end of the time period, 85% to 95% of students are earning an A or B, then change to the next scale. Both ways are appropriate and depend on student behavior data for decision making.

When it is time to change to the next level of grading scale, students need to know the details such as the number of rule violations they can make and still earn an “A” or one of the other letter grades, as well as the day the new scale will begin. It is important for students to know that the reason the scale will change is because their past behavior is indicating they are ready for the next level of expectation in terms of social behavior. In other words, most students should be fluent rule followers and earning good grades.

Several grading scales may be used in a reporting period and therefore the grade must be figured differently if more than one grading scale is used during the reporting period. The focus is on quality grading points assigned to each letter grade and not absolute number of checks. The grade is calculated using an enhanced quality points system. Given a particular grading scale, there is a unique decimal point value assigned to each number of checks the student may receive. These point values are calculated based on the range of checks assigned to each letter grade in that grading scale. The final grade across any number of scales, classes or dates is calculated by doing a simple average of all the point values by session and applying it to a standard GPA scale.

For example, if the range of checks assigned to each letter grade in the grading scale is as follows:

| | | Scaled |
|---|---|---|
| Grade | Checks | QPs |
| A | 0 | 4.4 |
| | 1 | 4.2 |
| | 2 | 4 |
| | 3 | 3.8 |
| | 4 | 3.6 |
| B | 5 | 3.3 |
| | 6 | 3 |
| | 7 | 2.7 |
| C | 8 | 2.3 |
| | 9 | 1.7 |
| D | 10 | 1 |

then, for grading scales R1 and R3 thru R6, the unique decimal point value assigned to each number of checks the student may receive can be as follows:

| # of | Scale | | | | |
|---|---|---|---|---|---|
| Checks | R1 | R3 | R4 | R5 | R6 |
| 0 | 4.3500 | 4.3125 | 4.3125 | 4.2857 | 4.2500 |
| 1 | 4.1750 | 4.1563 | 4.1563 | 4.0952 | 4.0833 |
| 2 | 4.0000 | 4.0000 | 4.0000 | 3.9048 | 3.9167 |
| 3 | 3.8250 | 3.8438 | 3.8438 | 3.7143 | 3.7500 |
| 4 | 3.6500 | 3.6875 | 3.6875 | 3.2857 | 3.0000 |
| 5 | 3.3500 | 3.0000 | 3.0000 | 2.7143 | 2.0000 |
| 6 | 3.0000 | 2.3125 | 2.3125 | 2.0000 | 1.0000 |
| 7 | 2.6500 | 1.6875 | 1.6875 | 1.0000 | 0.2500 |
| 8 | 2.3500 | 1.0000 | 1.0000 | 0.2857 | 0.0920 |
| 9 | 1.6500 | 0.3125 | 0.3125 | 0.1051 | 0.0338 |
| 10 | 1.0000 | 0.1150 | 0.1150 | 0.0387 | 0.0124 |
| 11 | 0.3500 | 0.0423 | 0.0423 | 0.0142 | 0.0046 |
| 12 | 0.1288 | 0.0156 | 0.0156 | 0.0052 | 0.0017 |
| 13 | 0.0474 | 0.0057 | 0.0057 | 0.0019 | 0.0006 |
| 14 | 0.0174 | 0.0021 | 0.0021 | 0.0007 | 0.0002 |
| 15 | 0.0064 | 0.0008 | 0.0008 | 0.0003 | 0.0001 |
| 16 | 0.0024 | 0.0003 | 0.0003 | 0.0001 | 0.0000 |

The table below illustrates an example of using the enhanced quality point system to calculate day, class, and overall grades for a student.

| | Class 1 | Class2 | Class 3 | Class 4 | Class 5 | | |
|---|---|---|---|---|---|---|---|
| | Scale R1 | Scale R3 | Scale R4 | Scale R5 | Scale R6 | Day | Day |
| Day 1 | Number of Checks | | | | | QP | Grade |
| Day 1 | 6 | 3 | 7 | 4 | 10 | 2.171 | C |
| Day 2 | 8 | 5 | 2 | 2 | 0 | 3.484 | B |
| Day 3 | 4 | 4 | 5 | 1 | 4 | 3.427 | B |
| Day 4 | 2 | 1 | 4 | 4 | 5 | 3.288 | B |
| Day 5 | 1 | 0 | 0 | 0 | 2 | 4.187 | A |
| Overall Class | 3.435 | 3.800 | 3.038 | 3.650 | 2.636 | | |
| QP Average | | | | | | | |
| Overall | B | A | B | A | B | | |
| Class Grade | | | | | | | |
| Overall | B | 3.3118 | | | | | |
| Grade | | | | | | | |

In the above example, for Class 1 on Day 1, the student had 6 checks, which corresponds to 3.000 quality points, which is a “B” letter grade based on the above scales. This calculation can be repeated for each subsequent class (i.e. class 2 thru class 5) for Day 1 to arrive at the Day Grade. The total number of quality points for each class for day 1 are added and divided by the total number of classes to obtain the quality points for the day. In this manner, the class, day, and overall grades can be calculated.

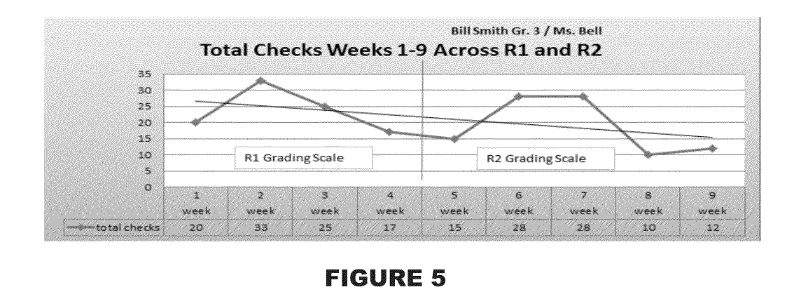

The one component of the plan that remains constant is adding the total number of checks by day and across time. FIG. 5 illustrates an example of a students' progress during the first 9 weeks of school. The student earned A's, B's, and C's during weeks 1-9. His rule violating behavior decreased from week 2-5 and then increased for 2 weeks; however, it did not exceed the highest number of rule violations (i.e., 33) observed in week 2. By week 8, the student's number of rule violations decreased once again. This scenario of a downward trend (i.e. decreasing rule violations) is normal for most students if the program is implemented with fidelity.

The following chart provides an example of a reinforcement and penalty plan for a particular time period (e.g., 60 minutes, 2 hours, 3 hours):

| DEMERITS | |
|---|---|
| 0-1 | Student receives a “ [symbol] ” sticker |
| 2-3 | Student does not receive a sticker, but receives words of |
| | encouragement |
| 4 | Student does not receive a sticker, but receives words of |
| | encouragement |
| 5 | Student receives a copy of the rules and must write the |
| | violated rule of conduct before the end of the day |
| 6 | Student attends behavior class during a recess period and |
| | must write the rules of conduct and describe the right way |
| | to behave |
| 7 | Student receives a 10 minute “time out” in back of class |
| | room and must write “stop and think” sentences |
| 8 | Student receives a form with the number of rules violated |
| | that must be signed by a parent and returned to the |
| | school the next day |

The Plan may also include a more extreme punishment for particularly disruptive behavior. For example, if a student rule violates more than 8 times during a scheduled time period, they will earn an “F” for the day or an office referral.

5. Progress Monitoring.

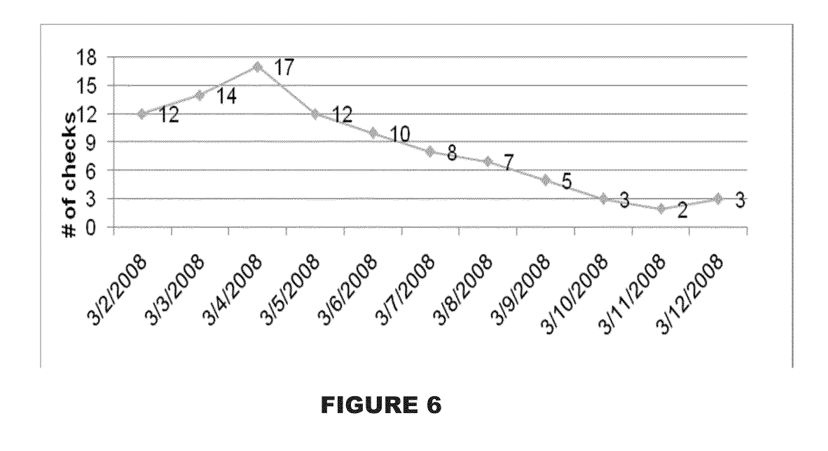

Once the plan is developed and students are trained, their progress should be monitored frequently and continuously. This is necessary if social behavioral performance is expected to match a set of teacher determined classroom expectations. It is likely that some students make more mistakes or violations than others. To see student performance, data should be plotted and analyzed for any changes. Watching these data allows more accurate next steps to be determined. A line graph or frequency polygon is a common format for the display of data. Line graphs are typically used to progress monitor or track student behavior. The number of violations is plotted daily and changes can be observed daily, weekly, or at any specified point in time. FIG. 6 illustrates an example of a graph that monitors the number of daily violations for a student.

6. Behavior Class.

The conceptual framework for learning basic compliance requires training students to become fluent in rule following. Listening and following teacher directions is essential for learning to take place in the classroom. Some students come to school with rule following behavior in their behavioral repertoire and others may come with either performance or skill deficit in rule following. Therefore, for students to be considered socially competent in school, they must learn to engage in rule following behaviors.

For students to become successful rule followers, they need to know the rules and how to perform them. With the method of this invention, there are two parts to the training that are necessary to maintain and increase rates of child compliance: 1) teachers need to clearly describe the program components such that students understand and can follow the program; and 2) there must be practice opportunities with performance feedback. Both parts are dependent on the teacher being able to successfully implement the components systematically, consistently and with integrity.

Behavior class is a formal class designed to teach and reinforce rule following in students across school years. Because the method is a behavioral program that includes observable and measurable behaviors and consequences and the measurement of rule following, it may take some time for both teacher and student to become fluent in both implementation and learning. The goal is to incorporate the program components in a routine manner across school years; it is not meant to be an add-on classroom management plan that is introduced the first week of school and then forgotten.

During behavior classes, students are taught the rules and the consequences and are provided practice time until they understand and can imitate the expectation. Behavior classes are similar to reading and math classes in that the teacher should ensure that all students know what they supposed to do. When students know the behaviors expected of them, they have no excuse for noncompliance. Behavior classes also hold students accountable when they do not follow the rules as instructed. A logical consequence for not following the rules is requiring practice during times that are inconvenient for the student (e.g., during recess, free time, etc.).

Behavior classes should be scheduled daily and occur at the start of the school day. This is reasonable because teaching expected behaviors will save class time in the long run. However, if students do not use the skills they have been taught, then practice should occur during students' free time. If students use up content time with play, then playtime should be used for review and practice of the social behaviors. Not only will this review and practice reinforce skill use, but it will also help students connect problem behaviors with consequences. The ultimate goal is to have basic rule following become routine. Compliance should be automatic and unnoticed by students and teachers.

During the first day and first week of school, behavior classes will require longer teaching time to ensure all components are taught. Teaching and describing each component includes telling, modeling, and practice. After the initial week of training and practice, students will need ongoing support to achieve “A” and “B” behavior because the expectations will change and earning an “A” may be more challenging for some.

The initial behavior class may require up to two hours to completely describe the program. During the remainder of the first week, behavior classes should range in time from twenty minutes to an hour to practice and discuss the rules and consequences depending on student rule following behavior. During the second week, behavior classes may range from five to twenty minutes depending on whether a new skill is introduced (e.g., using eye contact while asking a question) or students continue to practice skills they are have difficulty displaying.

Behavior classes are most effective when they are routine, systematic, and ongoing, just like any other class. It is most important to build good behavioral habits early in the school year. In fact, making a concerted effort to teach routine skills during the first grading period will ensure they become automatic and will increase academic learning time. In addition to being taught early in the school year, behavior classes should be taught regularly. A time should be scheduled each day for behavior classes, just as core subjects. Some teachers incorporate behavior classes into a morning class meeting. The advantage of this time slot is that it can be used extensively for behavior classes early in the year and can be used for other school needs as the year progresses.

Material is taught in behavior classes through a five-step process: (1) telling students the skill to be learned, (2) showing students how the skill should and should not be performed, (3) having students do the skill, (4) having students practice the skill, and (5) monitoring and re-teaching the skill. The first three steps constitute the formal classroom lesson. Practice opportunities should be frequent at first and embedded in the normal classroom routines. During the monitor and re-teach phase, students are expected to perform the skill correctly. If students don't use the skill correctly, they should participate in re-teaching sessions as needed.

In the initial behavior class, first gain student attention, and then introduce the topic. It is also important to provide a rationale for why the skill is important.

Show the class exactly how the skill is to be performed. Often it is helpful to have students assist with the demonstration. Include both “right way-wrong way” examples. In other words, show students what to do and what not to do. Avoid gray areas, which are vague and open to interpretation. Explain that there are correct ways to do the task and that there are incorrect ways to do the task.

Doing or practicing the new behavior provides an opportunity for the entire class to perform the skill. It is preferred that at least five opportunities are provided for the class to perform the skill during the introductory lesson. Student behavior should be closely monitored during their performance, and feedback provided about correct and incorrect performance. It is preferred that positive feedback is provided during this monitoring which will continue to reinforce the right way to engage in the skill. Attention of the teacher and that of the students should be directed toward those who are making improvements to further aid in building the appropriate skills.

The basic premise of the method is that student social behavior should steadily improve. As student behavior meets expectations, then it is preferred that expectations should be raised for rule following and teaching pro-social skills. In this context it can be desirable for the student to have easy and ready access to that student's history in learning correct social behavior in a classroom environment. Thus, assembling the collected data for a student in a format that effectively conveys that student's progress in learning and using the rules of conduct for correct social behavior in a classroom environment, and in a manner that can be provided to the student is highly desirable. One method to provide the desired information to a student is through the teacher inputting the data (e.g., demerits earned during given periods and the social behavior grades earned during those given periods) into a data base program that can provide tables, graphs and/or charts indicating the progress and status of the student in learning and using the correct social behavior in a classroom environment. The student can be provided limited access to the data base to receive this information regarding that student's performance over time.

7. Ongoing Training and Support.

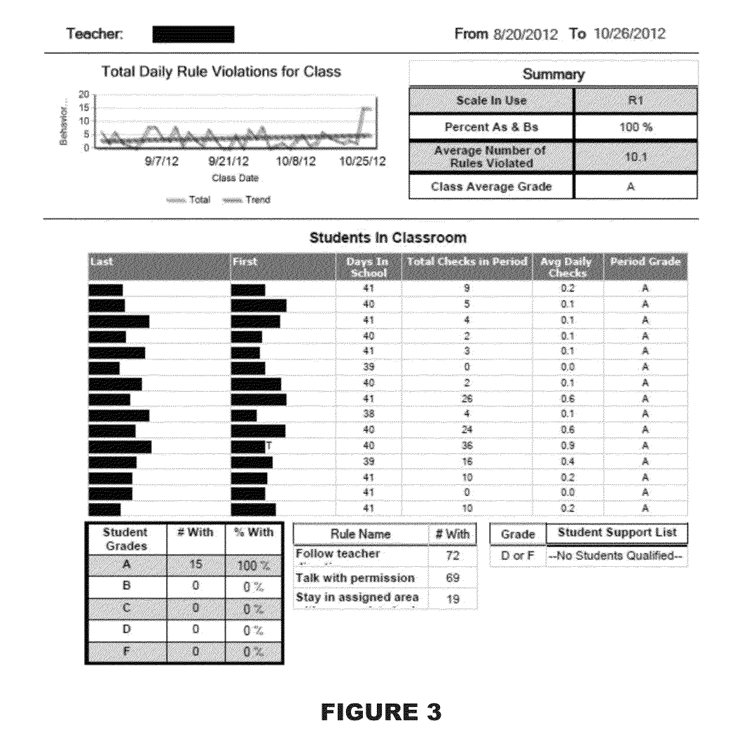

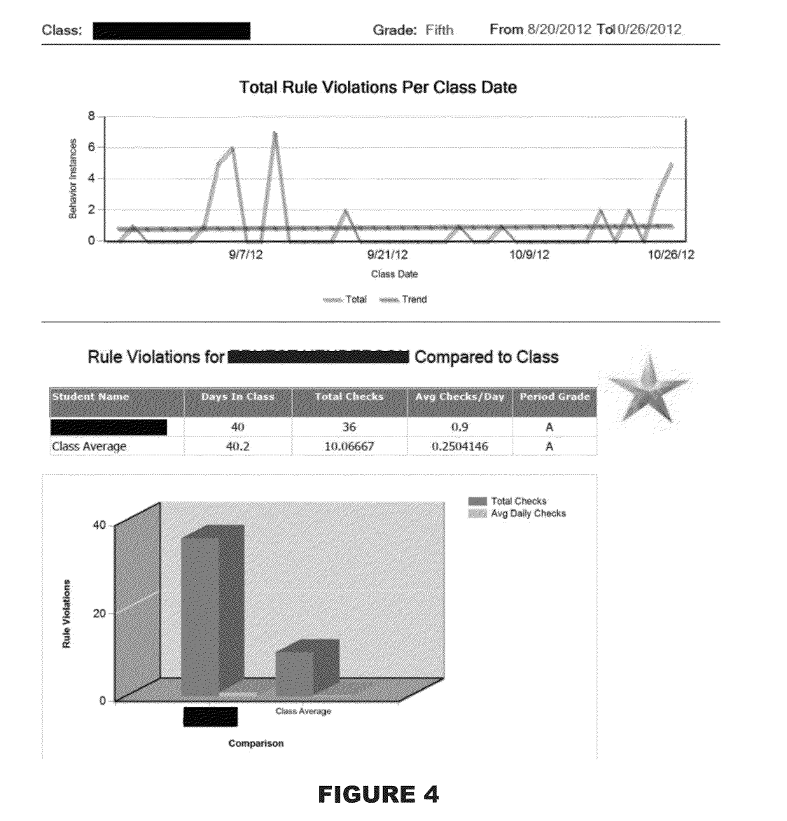

The data collected by the teacher can be utilized not only in teaching a student proper social behavior in a classroom environment, but can also be used in evaluating the performance of the teacher, a school or a school district. The type of reports in evaluating a student's performance includes graphs of total demerits recorded by a teacher during a class period, during a day, during a week or during longer periods, such as a grade reporting period or a school year. As shown in FIG. 3, the report(s) can also illustrate class performance over a particular time with a summary the performance of each student in the class. The report(s) can also illustrate a student's performance compared to the rest of the students in a particular class as shown in FIG. 4.

Similar graphs can be generated to evaluate a teacher. In those graphs the total demerits of all students recorded by teacher would be graphed against the time period selected. In evaluating a school the total demerits of all students recorded by all teachers in that school would be graphed against the time period selected. If desired graphs can be generated that reflect the performance of a student or a teacher over a selected time period against the performance of all students or against the performance of all teachers, respectively. Still further graphs can be generated that reflect the total amount of demerits awarded by one teacher or all teachers in a school for violation of a particular rule of conduct over a selected time period to assist in evaluating where emphasis may need to be placed. Other comparative data graphs can be created from the fields of data collected. The aforementioned data can be reported using a computer based application (e.g. web application). As discussed above, in an embodiment, the computer comprises a CPU and memory unit having control logic stored therein to report collected data. The web application can include a dashboard that summarizes the data for a school in a variety of ways (e.g. by teacher, school, school district, and so forth). In this manner, supervisors and/or administrators (e.g. guidance counselor, principal, school superintendent, school board, etc.) can readily access and monitor and evaluate teacher and student performance. This can also permit a supervisor to determine if additional training and/or other strategies are needed to address any issues.

The use of a handheld computer device in recording the student social behavior observations is preferred. It is preferred that student rule violating behavior is recorded using a handheld or tablet computer that utilizes a web based application to process and print the desired type of report. Examples of handheld or tablet computers include, but are not limited to, iPod®, iPhone®, iPad®, Kindle Fire®, and so forth.

Any reference to patents, documents and other writings contained herein shall not be construed as an admission as to their status with respect to being or not being prior art. Although the present invention and its advantages have been described in detail, it is understood that the array of features and embodiments taught herein may be combined and rearranged in a large number of additional combinations not directly disclosed, as will be apparent to one having ordinary skill in the art.

Moreover, it should be understood that various changes, substitutions and alterations can be made herein without departing from the spirit and scope of the invention as defined by the following claims. There are, of course, other alternate embodiments, which are obvious from the foregoing descriptions of the invention, which are intended to be included within the scope of the invention, as defined by the following claims.

What is claimed is:

1. A method for teaching social behavior to students comprising the steps of:
a. identifying rules of conduct;
b. establishing positive consequences for obeying the rules of conduct and establishing negative consequences for disobeying the rules of conduct;
c. teaching the students the rules of conduct and the consequences for obeying and disobeying the rules of conduct;
d. tracking and recording the conduct of students in disobeying the rules of conduct at or near the actual time it occurs;
e. establishing a grading scale and assigning to the students a grade based on their conduct and the grading scale;
f. monitoring over time the changes to the grade;
g. conducting behavior class for the students; and
h. re-evaluating the grading scale based on the grade made by the students over time.

2. The method according to claim 1 wherein the rules of conduct comprise:
a. follow teacher directions;
b. keep hands, feet and objects to oneself;
c. raise hand for teacher attention or to talk;
d. stay in assigned area using appropriate body behavior; and
e. keep unkind comments to oneself.

3. The method according to claim 1 wherein each of the rules of conduct observable by a teacher in a classroom environment and recordable by a teacher in a classroom environment.

4. The method according to claim 1 wherein the grading system varies over time.

5. The method according to claim 1 wherein the teaching is in a behavior class.

6. A computer-implemented method for tracking a student's behavior using a computer system having a central processing unit (CPU), a memory unit having a control logic stored therein, said control logic comprising the steps of:
a. tracking and recording the conduct of the student in disobeying rules of conduct

7. The method according to claim 6 wherein the rules of conduct comprise:
a. follow teacher directions;
b. keep hands, feet and objects to oneself;
c. raise hand for teacher attention or to talk;
d. stay in assigned area using appropriate body behavior; and
e. keep unkind comments to oneself.

8. The method according to claim 7 further comprising:
a. tracking and recording the attendance of the student.

9. The method according to claim 8 wherein the tracking and recording occurs at or near the actual time it occurs.

10. The method according to claim 9 wherein the tracking and recording the conduct of students in disobeying the rules of conduct is done by both the student and a teacher.

11. The method according to claim 10 wherein the student tracking and recording is compared to the teacher tracking and recording.

12. A computer-implemented method for tracking a student or teacher performance using a computer system having a central processing unit (CPU), a memory unit having a control logic stored therein, said control logic comprising the steps of:
a. tracking and recording instances of a student disobeying rules of conduct;
b. generating reports based on the tracked and recorded instances of a student disobeying rules of conduct.

13. The method according to claim 12 wherein the rules of conduct comprise:
a. follow teacher directions;
b. keep hands, feet and objects to oneself;
c. raise hand for teacher attention or to talk;
d. stay in assigned area using appropriate body behavior; and
e. keep unkind comments to oneself.

14. The method according to claim 13 further comprising:
a. tracking and recording the attendance of the student.

15. The method according to claim 14 wherein the tracking and recording occurs at or near the actual time it occurs.
